(19) United States
(12) Patent Application Publication
(10) Pub. No.: US 2010/0073398 A1
(43) Pub. Date: Mar. 25, 2010

(54) VISUAL SUMMARIZATION OF WEB PAGES

(75) Inventors: Danyel Fisher, Seattle, WA (US); Jaime B. Teevan, Bellevue, WA (US); Steven M. Drucker, Bellevue, WA (US); Edward Cutrell, Seattle, WA (US); Gonzalo A. Ramos, Bellevue, WA (US); Joseph Pitt, Seattle, WA (US); Paul Andre, Christchurch (GB)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/235,335

(22) Filed: Sep. 22, 2008

(51) Int. Cl. G09G 5/00

(52) U.S. Cl. 345/619

(57) ABSTRACT

A visual summarization of a web page is generated. This generally involves identifying at least one of, an image that is exemplary of the page content, text that is exemplary of the page content, and a logo associated with the web page. The exemplary image and logo, if identified, are scaled to prescribed sizes. The exemplary image can act as a background image for the summarization, or a scaled version of the at least a portion of the web page can act as the background image. In the latter, if an exemplary image was identified, it is overlaid onto the background image at a prescribed location. In either case, if a logo was identified, it is also overlaid onto the background image at a prescribed location. If exemplary text was identified, a text area in the background image is identified and at least some of the exemplary text is inserted.

### BACKGROUND

A web page is accessed from a web site on a computer network (such as the World Wide Web on the Internet) and can be displayed via a computer monitor. Each web page may include text, graphics and links to files, other web pages, audio and video sources, among other things. The web pages are rendered from files that can be generated using HyperText Markup Language (HTML), Dynamic HyperText Markup Language (DHTML), or JavaScript, among others, and each page is identified by a unique Uniform Resource Locator (URL).

People regularly interact with many different web pages. To find web pages of interest, a person may employ a search engine. Search engines typically represent their search results as textual snippets, with a title, a query based page summary, and URL. When that person wants to return to the same page later, they may interact with the page as a link in their network browser history. Previously viewed web pages are represented in many ways. For example, a page can be represented as a title in the browser history, as a search result caption, as a URL in a browser address bar, and so on.

### SUMMARY

Web page visual summarization embodiments described herein provide for visually summarizing a web page in a form that when rendered produces a summarization that is smaller than the web page, but which allows a viewer to discern the content of the page. This takes advantage of people's ability to quickly recognize visual images. In one embodiment, visually summarizing a web page involves first identifying an image associated with the web page that is exemplary of the page content. The summarization then entails identifying at least one of, text associated with the web page that is exemplary of the page content, and a logo associated with the web page. The aforementioned exemplary image is cropped to a prescribed aspect ratio and scaled to a prescribed size, which is smaller than the size of the web page. In addition, if a logo was identified, it is scaled to fit within a prescribed-sized area while preserving its original aspect ratio. This scaled logo is then overlaid onto the cropped and scaled exemplary image at a prescribed position. If exemplary text was identified, a prescribed-sized text area of the cropped and scaled image is identified. This text area is used for inserting the identified text. More particularly, a prescribed number of the characters of the identified text (e.g., the first-occurring characters) are inserted into the text area. The result of the foregoing preprocessing and composing is one version of the desired web page visual summarization.

In another embodiment, visually summarizing a web page involves first identifying at least one of, an image associated with the web page that is exemplary of the page content, text associated with the web page that is exemplary of the page content, and a logo associated with the web page. Next, the web page being summarized is scaled to a prescribed size to create a background image. If an exemplary image was identified, it is scaled to a prescribed size which is smaller than the size of the background image. In addition, if a logo was identified, it is scaled to fit within a prescribed-sized area while preserving its original aspect ratio. Further, if exemplary text was identified, a prescribed-sized text area of the background image is identified. This text area is used for inserting the at least a portion of the identified text. To this end, a prescribed number of the characters of the identified text (e.g., the first-occurring characters) are inserted into the text area. Next, if a logo was identified, its now scaled version is overlaid onto the background image at a prescribed position. Likewise, if an exemplary image was identified, its now scaled version is overlaid onto the background image at a prescribed position. The result of the foregoing preprocessing and composing is an alternate version of the desired web page visual summarization.

It is noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a simplified block diagram of one exemplary embodiment of a web page visual summarization composition that employs an image that is exemplary of the page content as the background.

FIGS. 2A-B are a continuing flow diagram generally outlining one embodiment of a process for visually summarizing a web page using a scaled version of an image that is exemplary of the page content as the background.

FIG. 3 is a simplified block diagram of one exemplary embodiment of a web page visual summarization composition that employs a scaled version of the web page as the background.

FIGS. 4A-B are a continuing flow diagram generally outlining one embodiment of a process for visually summarizing a web page using a scaled version of at least part of the web page being summarized as the background.

FIG. 5 is a diagram depicting a general purpose computing device constituting an exemplary system for implementing web page visual summarization embodiments described herein.

### DETAILED DESCRIPTION

In the following description of web page visual summarization technique embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

### 1.0 Web Page Visual Summarization

Web page visual summarization embodiments described herein provide a compact way to represent web pages that efficiently supports a variety of interactions. For example, these include the identification of new, relevant web pages and the finding of previously viewed web pages. The web page visual summarization embodiments described herein take advantage of people's ability to quickly recognize visual images.

In general, a web page is represented by a visual summarization that can be as small as about 120×90 pixels. Because the web page representations are so small, they present many advantages for search and re-visitation of previously visited web pages. For one, a large number of web page representations can be viewed at once. This is particularly advantageous for mobile devices, where display screen real estate is limited, but also beneficial for history functionality where a large number of pages are viewed at once. Further, these small web page visual representations could be used to complement text snippets in search result pages. With only a small reduction in the amount of text, the hybrid snippet could occupy the same amount of space as current search result entries comprising title, text snippet, URL and page metadata.

### 1.1 Visual Summarization Design

In one embodiment, web page visual summarization represents a web page using three elements. These elements are an image associated with the web page that is exemplary of the page content, text associated with the web page that is exemplary of the page content and a logo associated with the web page. It is noted that some web pages may not have text associated with them, and some web pages may not have a logo associated with them. Thus, in other embodiments, there can be just two elements—namely, either an image and text, or an image and logo. Still further, it is not intended to limit the visual summarization of a web page to only a maximum of three elements. Other elements could also be added, such as one or more additional text elements.

### 1.2 Visual Summarization Generation

A visual summarization of a web page is generated by identifying the elements that are to be used in the summarization, and then compiling these elements in a prescribed way. This generally involves identifying at least one of, an image that is exemplary of the page content, text that is exemplary of the page content, and a logo associated with the web page. The exemplary image and logo, if identified, are scaled to prescribed sizes. The exemplary image can act as a background image for the summarization, or a scaled version of at least a portion of the web page can act as the background image. In the latter, if an exemplary image was identified, it is overlaid onto the background image at a prescribed location. In either case, if a logo was identified, it is also overlaid onto the background image at a prescribed location. In addition, in either case, if exemplary text was identified, a text area in the background image is identified and at least some of the exemplary text is inserted.

The identification of the components elements of the web page visual summarization will be described first. This will be followed with a description of embodiments using an identified exemplary image as the background. Then, embodiments where a scaled version of at least part of the web page is used as a background image will be described.

### 1.2.1 Identifying the Component Elements

As described previously, in some embodiments, there are up to three component elements that are used to make up a visual summarization of a web page—namely an image associated with the web page that is exemplary of the page content, text associated with the web page that is exemplary of the page content and a logo associated with the web page. The image element is identified using conventional methods, such as machine learning techniques, site-based templates, algorithms for image analysis (e.g., face or object recognition), image metadata included in the source (e.g., image title or filename), link structure surrounding the image (e.g., does clicking on the image lead somewhere), or heuristics concerning image placement and size, and can come from the web page itself or an outside source. The key is that the image reflects the content of the web page. For example, the image can be a salient image shown in the rendered web page. With regard to the text element, in one embodiment, the title of the web page as found in the header portion of the file used to render the page is identified and used. However, the text element could also be found in the rendered web page itself, or identified from an outside source. It also need not be the title of the web page. Here again the key is that the text element be exemplary of the content of the web page. With regard to the logo element, it is identified using the same kinds of conventional methods outlined above for identifying salient images, as well as others that are specific to logos, such as whether the logo is shared between multiple pages, and can come from the web page itself or an outside source. In general, the logo can be defined as a relatively small image that is commonly associated with most pages on a site and uniquely marks the organization, business or Web site that the page is associated with.

### 1.2.2 Using the Exemplary Image as the Background

As indicated previously, in some embodiments an identified exemplary image is used as the background for the web page visual summarization. In general, these embodiments entail first identifying the exemplary image, and at least one of a logo or exemplary text in the manner described previously. Once these component elements are identified, they are preprocessed and automatically compiled. The following paragraphs described this procedure.

### 1.2.2.1 Cropping And Scaling The Exemplary Image

In one embodiment, the exemplary image identified as described previously is cropped to a prescribed aspect ratio. For example, an aspect ratio of 4×3 was employed in tested embodiments. The cropped image is then scaled to a prescribed size representing the final size of the web page visual summarization. In tested embodiments, the cropped image was scaled to a size of 120×90 pixels.

### 1.2.2.2 Scaling The Logo

In one embodiment, the aforementioned logo, if used, is scaled to fit within a prescribed area, while preserving its original aspect ratio. The logo's scale is chosen so that it either fills half of the height of the web page visual summarization, or the full width of the web page visual summarization, which ever comes first (or both at the same time). Thus, for example, the original aspect ratio of the logo might be such that the scaling causes it to fill the full width of the visual summarization before its height reaches half the height of the summarization. The original aspect ratio might also be such that scaling causes the logo to reach the half way point of the visual summarization before its width reaches the full width of the summarization. It is noted that in tested embodiments, the prescribed sized area was set to 120×45 pixels for an overall visual summarization size of 120×90 pixels.

### 1.2.2.3 Cropping The Exemplary Text

A prescribed number of the characters of the previously identified exemplary text are used in the web page visual summarization. In tested embodiments, the first 19 characters of the exemplary text were used. It has been demonstrated in the past that the leftmost 15-20 characters of a web page's title can yield acceptable site recognition. To provide for a better recognition outcome, it was demonstrated that 30-39 characters would be required. Text strings of this length are possible in generating a web page visual summarization, however would require a larger overall size.

### 1.2.2.4 Composing The Pieces

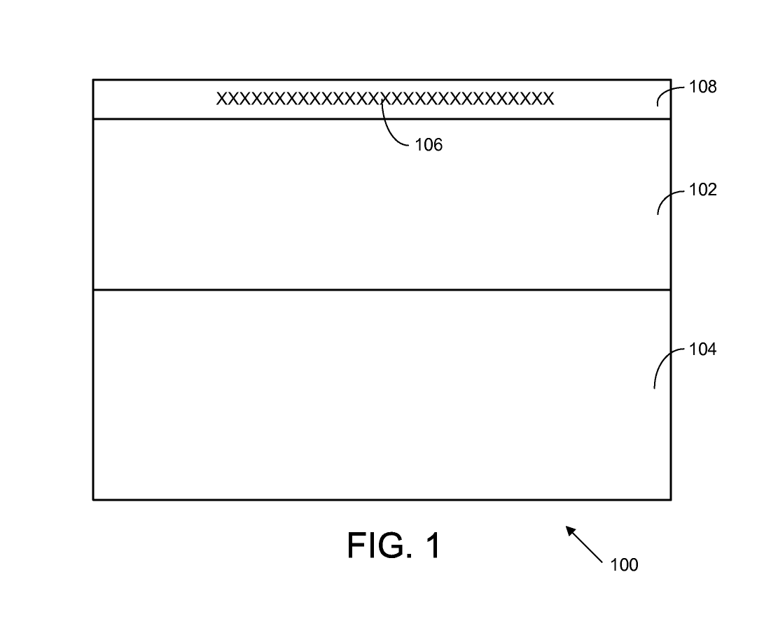

FIG. 1 shows one exemplary embodiment of a template 100 that can be used to automatically generate a web page visual summarization. It is noted that this template 100 assumes that both a logo and exemplary text elements are available and used in combination with an exemplary image. If this is not the case, the logo or the exemplary text element, as the case may be, is eliminated. The three elements, pre-processed as described previously, are composed as shown in FIG. 1.

More particularly, assuming a logo is to be included, its scaled version 104 is laid over the cropped and scaled exemplary image 102 at a prescribed position. In the example of FIG. 1, this prescribed position is at the bottom of the image 102. However, any position which would keep the scaled logo within the boundaries of the cropped and scaled exemplary image could be employed instead. It is noted that the maximum possible size for the logo element is shown in FIG. 1 (i.e., half the height and the full width of the cropped and scaled image). The logo area can be smaller as described previously. Further, in one embodiment, the opacity of the scaled logo 104 is set to a prescribed level. For example, the scaled logo's opacity was set to about 30% in tested embodiments, although other levels could be used instead.

Assuming a cropped text element 106 is to be included in the web page virtual summarization, a prescribed-sized text area 108 of the cropped and scaled image 102 is identified. In one embodiment, this text area 108 is located in a region at the top of the cropped and scaled image 102, as shown in the exemplary template of FIG. 1. However, this need not be the case. The text area could be located at any prescribed location within the cropped and scaled image as desired.

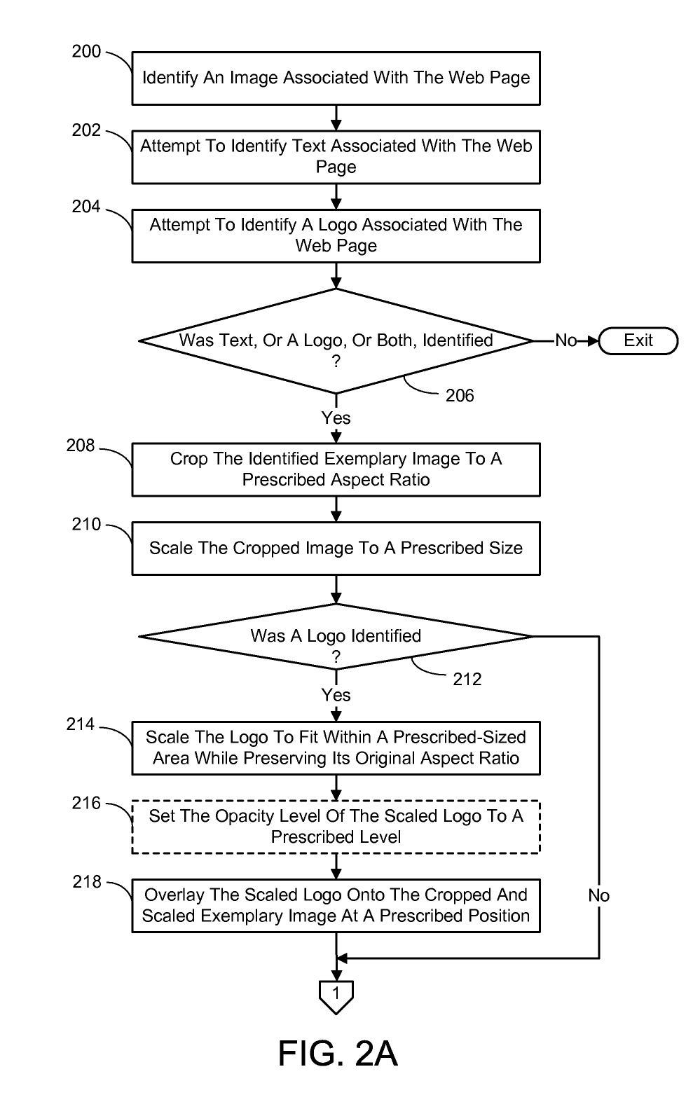

Given the foregoing, in one embodiment, a web page visual summarization can be generated as shown in FIGS. 2A-B. The generation begins with the identification of an image associated with the web page (200). This image is exemplary of the page content, and can be an image seen within the rendered and displayed web page, or can be an image from a source outside the web page. Next, an attempt is made to identify text associated with the web page (202). This text should be exemplary of the page content, and can be text seen within the rendered and displayed web page, or text found in the file used to render the web page, or text from a source outside the web page. In tested embodiments, the title of the web page as found in the header of the web page file was employed as the exemplary text. In addition, an attempt is made to identify a logo (as defined previously) associated with the web page (204). Again, the logo can be seen within the rendered and displayed web page, or can be a logo from a source outside the web page. It is then determined if the text, or the logo, or both, were identified (206). If not, a visual summarization of the web page cannot be generated. However, if at least one of the foregoing two elements are identified (as will almost always be the case), a web page visual summarization can be generated.

To this end, the image, and the text and/or logo, are pre-processed before being composed into the visual summarization. Referring again to FIGS. 2A-B, the preprocessing of the identified exemplary image entails cropping it to a prescribed aspect ratio (208) and scaling the cropped image to a prescribed size which is smaller than the size of the web page (210). As indicated previously, in tested embodiments the prescribed aspect ratio was 4×3, and the prescribed cropped image size was 120×90 pixels. It is next determined if a logo was identified (212). If so, the logo is scaled to fit within a prescribed-sized area while preserving its original aspect ratio (214). As indicated previously, in tested embodiments this entailed either scaling the logo so that it fills up to half of the height of the web page visual summarization, but does not exceed the full width of the web page visual summarization, or scaling the logo so that it fills up to the full width of the web page visual summarization, but does not exceed half of the height of the web page visual summarization. The logo's original aspect ratio will determine which scaling is undertaken. In addition, the opacity level of the scaled logo can optionally be set to a prescribed level (216). The optional nature of this last action is indicated in FIG. 2A by the use of a dashed line box. In tested embodiments, the opacity level was set to about 30 percent. The scaled logo is then overlaid onto the cropped and scaled exemplary image at a prescribed position (218). In tested embodiments, this prescribed logo position was at the bottom of the cropped and scaled exemplary image.

The generation of the web page visual summarization continues, regardless of if a logo was identified or not, with the preprocessing and composing of the any identified text. This entails first determining if any exemplary text was identified (220). If not, the web page visual summarization is deemed complete (226) and the generation procedure ends. If, however, exemplary text was identified, then a prescribed-sized text area of the cropped and scaled image is identified (222). The text area will be used for inserting the identified text associated with the web page. To this end, a prescribed number of the characters of the identified text are inserted into the text area (224). In tested embodiments, the first 19 characters of the exemplary text were used as the prescribed number. The web page visual summarization is then deemed complete (226) and the generation procedure ends.

It is noted that to avoid interfering with the recognizability of the cropped and scaled image and/or the scaled logo, the text area can be placed in a region of the image which does not overlie the logo, and which does not cover up the dominant features of the depicted scene. For example, the text area could be placed in a region of the cropped and scaled image that exhibits a low contrast, as this would indicate the region does not contain dominating features of the scene. Once the text area is identified, the cropped text element is inserted into it.

It is further noted that the color of the pixels within the text area can optionally be changed to provide a contrasting background for the cropped text element. It is also possible to change the color, or other aspects (e.g., style), of the text characters to provide a contract to the color (either original or changed) of the text area. In this way, the text of the cropped text element will stand out in the web page visual summarization thereby increasing its readability. For example, the color of the pixels of the text area could be changed from that of the cropped and scaled image to white. In addition, black text characters can be employed to provide a high contract to the white background.

With regard to the aforementioned optional additional text elements of the web page visual summarization, in one embodiment, this is implemented by identifying one or more additional prescribed-sized text areas of the previously cropped and scaled image. One or more additional text strings matching the number of additional text areas are then identified. These additional text strings can be associated with the web page in that they are exemplary of the page content. Next, for each additional text area identified, a prescribed number of the characters (e.g., the first-occurring characters) of one of the identified additional text strings are inserted therein. It is noted that the aforementioned cropping and scaling of the identified image can be done in such a way as to create opportunities for additional text areas.

### 1.2.3 Using the Web Page as the Background

As indicated previously, in some embodiments a scaled version of at least part of the web page being summarized is used as the background for the web page visual summarization. In general, these embodiments entail first identifying at least one of, an exemplary image, a logo or exemplary text in the manner described previously. Once these component elements are identified, they are preprocessed and automatically compiled. The following paragraphs described this procedure.

### 1.2.3.1 Using a Portion of the Web Page as a Replacement

In one embodiment, the web page visual summarization is generated as described above, except in this case an exemplary image could not be found. In such a case, a portion of the web page itself can be used in its place to form the background of the summarization. More particularly, a snapshot of a portion of the rendered webpage is used. This snapshot can include text, images, and so on. In some tested embodiments, the top 1024×768 pixels of the rendered web page was captured for use in place of the aforementioned exemplary image.

### 1.2.3.2 Using the Web Page as a Background Image

In an alternate embodiment of the above-described generation of a web page visual summarization, the component elements are identified and preprocessed as described previously, with one exception. Rather than scaling the image element to the size of the final visual summarization, it is scaled to a lesser size. In addition, a background image for the visual summarization is generated by scaling the web page (or a portion thereof) to the desired final size of the summarization. The preprocessed component elements are then overlaid onto the background image.

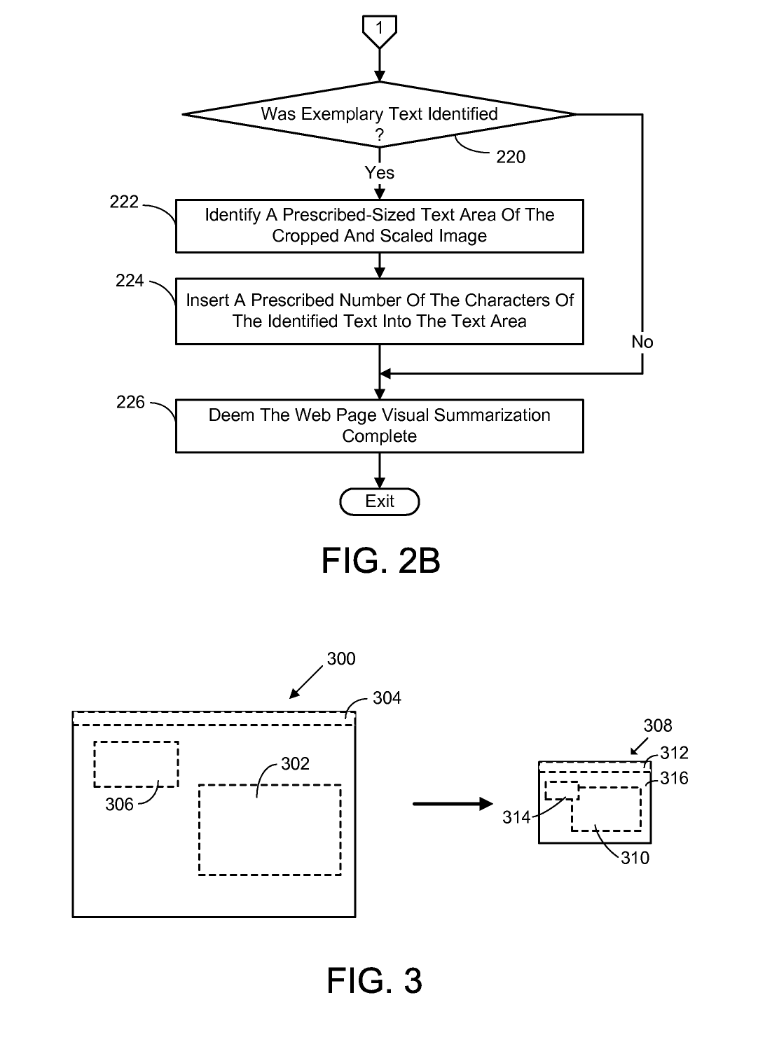

FIG. 3 illustrates the foregoing alternate web page visual summarization composition embodiment. On the left hand side, a simplified block depiction of a web page 300 is shown with the locations of an exemplary image 302, exemplary text 304, and logo 306 elements indicated by the dashed-line boxes. On the right hand side, a simplified block depiction of a web page visual summarization 308 is shown. The pre-processed (e.g., cropped and/or scaled) versions of the exemplary image 310, exemplary text 312, and logo 314 elements are shown overlaid on the background image 316 (which is a scaled version of the original web page). Note that the pre-processed logo element 314 overlaps the exemplary image 310 in this example. It is also noted that three component elements are employed in the foregoing example. This need not be the case. This alternate embodiment of the web page visual summarization can include any one of the elements only, or any combination of two of the elements. Other elements can also be added, such as one of more additional text elements.

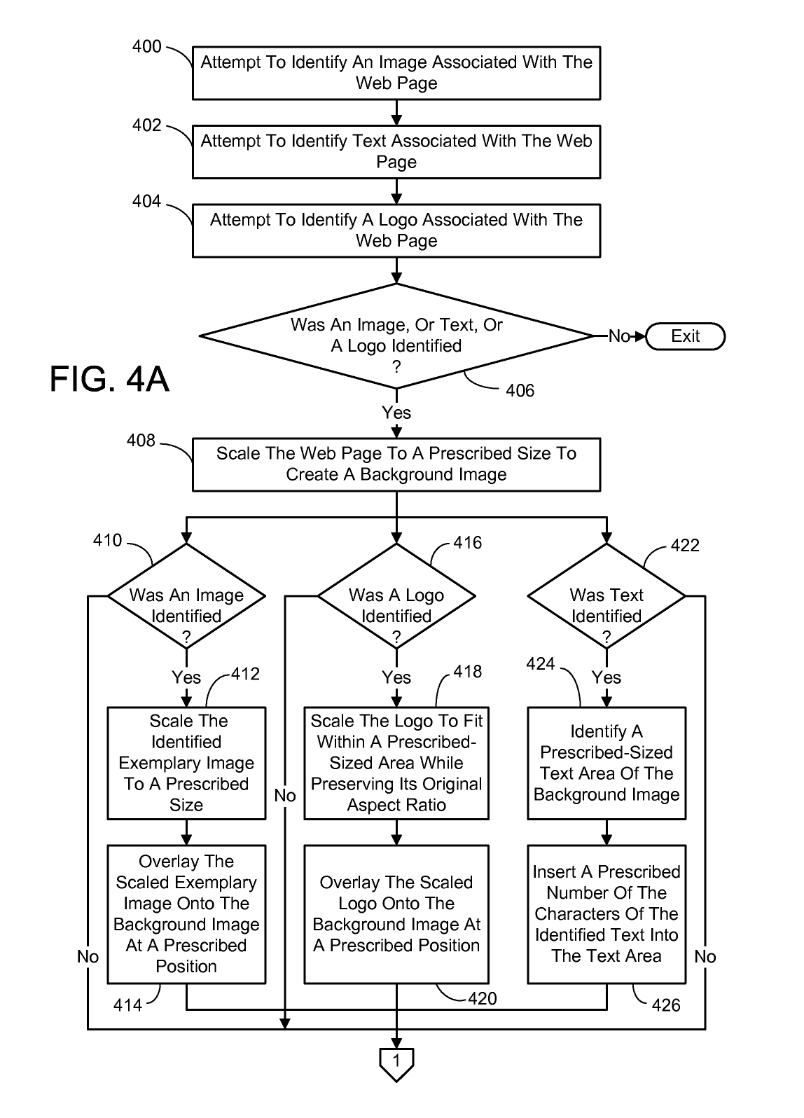

Given the foregoing, in one embodiment, the alternate web page visual summarization can be generated as shown in FIGS. 4A-B. The generation begins with an attempt to identify an image associated with the web page (400). As with the previously-described embodiments, this image should be exemplary of the page content, and can be an image seen within the rendered and displayed web page, or can be an image from a source outside the web page. Next, an attempt is made to identify text associated with the web page (402). This text should be exemplary of the page content, and can be text seen within the rendered and displayed web page, or text found in the file used to render the web page, or text from a source outside the web page. As with previously-described embodiments, the title of the web page as found in the header of the web page file can be employed as the exemplary text. An attempt is also made to identify a logo (as defined previously) associated with the web page (404). Again, the logo can be seen within the rendered and displayed web page, or can be a logo from a source outside the web page.

It is next determined if an exemplary image, or text, or the logo was identified (406). If not, a visual summarization of the web page cannot be generated. However, if at least one of the foregoing three elements are identified (as will almost always be the case), a web page visual summarization can be generated. If one or more of the three elements are identified, the visual summarization continues by scaling the web page to a prescribed size to create a background image (408). The prescribed size of the background image matches the desired size of the web page visual summarization, and can be, for example, 120×90 pixels. It is next determined if an exemplary image was identified (410). If so, the identified exemplary image is scaled to a prescribed size which is smaller than the size of the background image (412). For example, the scaled size could be a parameterized value dependent on the overall scaling of the larger image; initially small images might be 20% of the final total summary size and larger images might be 50%. The scaled exemplary image is then overlaid onto the background image at a prescribed position (414).

It is also determined if a logo was identified (416). If so, the logo is scaled to fit within a prescribed-sized area while preserving its original aspect ratio (418). The scaled logo is then overlaid onto the background image at a prescribed position (420).

It is also determined if any exemplary text was identified (422). If so, then a prescribed-sized text area of the background image is identified (424). The text area will be used for inserting the identified text associated with the web page. To this end, a prescribed number of the characters of the identified text are inserted into the text area (426). For example, the first 19 characters of the exemplary text can be used as the prescribed number. Once those component elements (i.e., exemplary image, exemplary text, logo) that were identified have been preprocessed and composed on the background image, the alternate web page visual summarization is then deemed complete (428) and the generation procedure ends.

The prescribed positions of the exemplary image and logo, and the position of the text area, can be any desired, but should not extend beyond the boundaries of the background image. In addition, the positions of these component elements (or at least the ones that were identified and composed on the background image) can be such that the elements overlap. In one embodiment, for those component elements that are seen within the rendered and displayed web page, their prescribed position corresponds to the location of that element as seen within the rendered and displayed web page, but offset if needed to prevent the element from extending beyond the boundaries of the background image.

### 2.0 Other Embodiments

It is further noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### 3.0 The Computing Environment

A brief, general description of a suitable computing environment in which portions of the web page visual summarization embodiments described herein may be implemented will now be described. The technique embodiments are operational with numerous general purpose or special purpose computing system environments or configurations. Examples of well known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

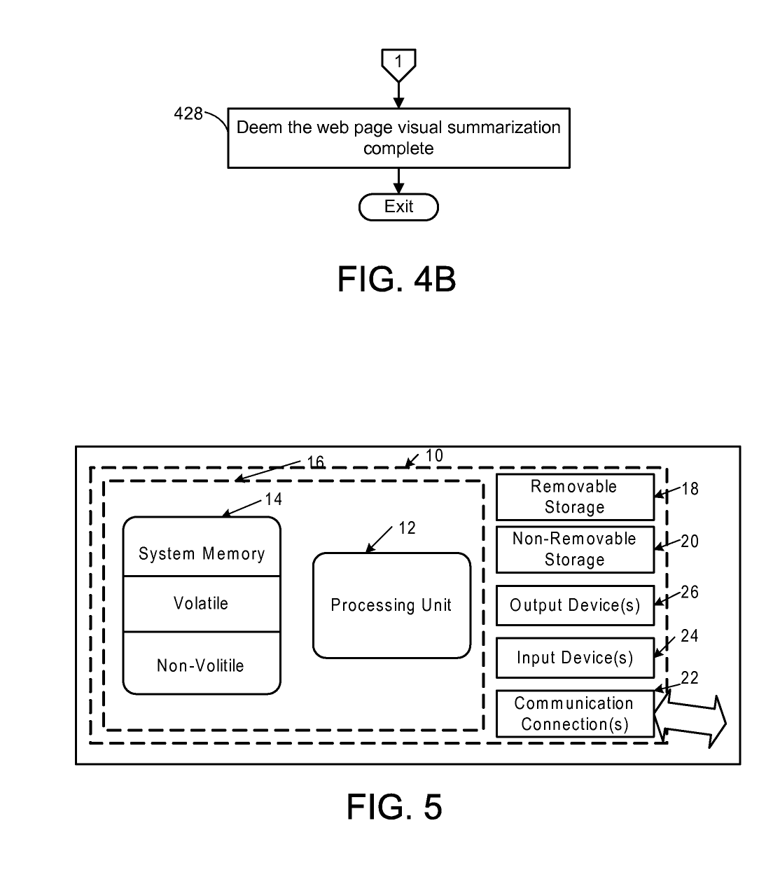

FIG. 5 illustrates an example of a suitable computing system environment. The computing system environment is only one example of a suitable computing environment and is not intended to suggest any limitation as to the scope of use or functionality of web page visual summarization embodiments described herein. Neither should the computing environment be interpreted as having any dependency or requirement relating to any one or combination of components illustrated in the exemplary operating environment. With reference to FIG. 5, an exemplary system for implementing the embodiments described herein includes a computing device, such as computing device 10. In its most basic configuration, computing device 10 typically includes at least one processing unit 12 and memory 14. Depending on the exact configuration and type of computing device, memory 14 may be volatile (such as RAM), non-volatile (such as ROM, flash memory, etc.) or some combination of the two. This most basic configuration is illustrated in FIG. 5 by dashed line 16. Additionally, device 10 may also have additional features/functionality. For example, device 10 may also include additional storage (removable and/or non-removable) including, but not limited to, magnetic or optical disks or tape. Such additional storage is illustrated in FIG. 5 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 10. Any such computer storage media may be part of device 10.

Device 10 may also contain communications connection(s) 22 that allow the device to communicate with other devices. Device 10 may also have input device(s) 24 such as keyboard, mouse, pen, voice input device, touch input device, camera, etc. Output device(s) 26 such as a display, speakers, printer, etc. may also be included. All these devices are well know in the art and need not be discussed at length here.

The web page visual summarization embodiments described herein may be further described in the general context of computer-executable instructions, such as program modules, being executed by a computing device. Generally, program modules include routines, programs, objects, components, data structures, etc. that perform particular tasks or implement particular abstract data types. The embodiments described herein may also be practiced in distributed computing environments where tasks are performed by remote processing devices that are linked through a communications network. In a distributed computing environment, program modules may be located in both local and remote computer storage media including memory storage devices.

Wherefore, what is claimed is:

1. A computer-implemented process for visually summarizing a web page in a form that when rendered produces a summarization that is smaller in size than the web page, comprising using a computer to perform the following process actions:
identifying an image associated with the web page that is exemplary of the page content;
identifying at least one of,
text associated with the web page that is exemplary of the page content, and
a logo associated with the web page;
cropping the identified exemplary image to a prescribed aspect ratio and scaling the cropped image to a prescribed size which is smaller than the size of the web page;
scaling the logo to fit within a prescribed-sized area while preserving the original aspect ratio of the logo, whenever a logo associated with the web page is identified;
overlaying the scaled logo onto the cropped and scaled exemplary image at a prescribed position, whenever a logo associated with the web page is identified;
identifying a prescribed-sized text area of the cropped and scaled image to be used for inserting text associated with the web page, whenever said text is identified; and
inserting a prescribed number of the characters of the identified text associated with the web page into the text area, whenever text associated with the web page is identified.

2. The process of claim 1, wherein the process action of identifying an image associated with the web page, comprises an action of identifying an image seen within the rendered and displayed web page.

3. The process of claim 1, wherein the process action of identifying an image associated with the web page, comprises an action of identifying an image from a source outside the web page, wherein the image is not seen within the rendered and displayed web page.

4. The process of claim 1, wherein the process action of identifying text associated with the web page, comprises an action of identifying text seen within the rendered and displayed web page.

5. The process of claim 1, wherein the process action of identifying text associated with the web page, comprises an action of identifying the title of the web page from a file from which the web page is rendered.

6. The process of claim 1, wherein the process action of identifying text associated with the web page, comprises an action of identifying text from a source outside the web page, wherein the text is not seen when the web page is rendered and displayed.

7. The process of claim 1, wherein the process action of identifying a logo associated with the web page, comprises an action of identifying a logo seen within the rendered and displayed web page.

8. The process of claim 1, wherein the process action of identifying a logo associated with the web page, comprises an action of identifying a logo from a source outside the web page, wherein the logo is not seen when the web page is rendered and displayed.

9. The process of claim 1, further comprising a process action of, prior to performing the process action of overlaying the scaled logo onto the cropped and scaled exemplary image, setting an opacity level of the scaled logo to a prescribed level.

10. The process of claim 1, wherein the process action of scaling the logo to fit within a prescribed-sized area while preserving the original aspect ratio of the logo, comprises an action of either:
scaling the logo so that it fills half of the height of the web page visual summarization, but does not exceed the full width of the web page visual summarization, or
scaling the logo so that it fills the full width of the web page visual summarization, but does not exceed half of the height of the web page visual summarization.

11. The process of claim 1, further comprising a process action of, prior to performing the process action of inserting a prescribed number of characters of the identified text associated with the web page into the text area, changing the color of pixels within the text area to a prescribed color which contrasts the color of the text characters.

12. The process of claim 1, further comprising a process action of, prior to performing the process action of inserting a prescribed number of characters of the text associated with the web page into the text area, changing the color of the text characters to contrast the color of the pixels within the text area.

13. The process of claim 1, further comprising the process actions of, whenever text associated with the web page is identified:
identifying one or more additional prescribed-sized text areas of the cropped and scaled image to be used for inserting text associated with the web page;
identifying one or more additional text strings matching the number of identified additional text areas; and
for each additional text area identified, inserting a prescribed number of the characters of a different one of the identified additional text strings.

14. A computer-implemented process for visually summarizing a web page in a form that when rendered produces a summarization that is smaller in size than the web page, comprising using a computer to perform the following process actions:
identifying at least one of,
an image associated with the web page that is exemplary of the page content,
text associated with the web page that is exemplary of the page content, and
a logo associated with the web page;
scaling at least a portion of the web page to a prescribed size matching a desired size of the web page visual summarization to create a background image;
scaling the image associated with the web page to a prescribed size which is smaller than the size of the background image, whenever an image associated with the web page is identified;
scaling the logo to fit within a prescribed-sized area while preserving the original aspect ratio of the logo, whenever a logo associated with the web page is identified;
identifying a prescribed-sized text area of the background image to be used for inserting text associated with the web page, whenever said text is identified;
inserting a prescribed number of the characters of the text associated with the web page into the text area, whenever text associated with the web page is identified;
overlaying the scaled logo onto the background image at a prescribed position, whenever a logo associated with the web page is identified; and
overlaying the scaled image onto the background image at a prescribed position, whenever an image associated with the web page is identified.

15. The process of claim 14, wherein the process action of identifying text associated with the web page, comprises an action of identifying text seen within the rendered and displayed web page, and wherein the location of the prescribed-sized text area of the background image corresponds to the location of said text seen within the rendered and displayed web page offset if needed to prevent the text area from extending beyond the boundaries of the background image.

16. The process of claim 14, wherein the process action of identifying a logo associated with the web page, comprises an action of identifying a logo seen within the rendered and displayed web page, and wherein the process action of overlaying the scaled logo onto the background image at a prescribed position comprises an action of overlaying the scaled logo in an area of the background image corresponding to the area where the logo appears in the rendered and displayed web page offset if needed to prevent the scaled logo from extending beyond the boundaries of the background image.

17. The process of claim 14, wherein the process action of identifying an image associated with the web page, comprises an action of identifying an image seen within the rendered and displayed web page, and wherein the process action of overlaying the scaled image onto the background image at a prescribed position comprises an action of overlaying the scaled image in an area of the background image corresponding to the area where said image appears in the rendered and displayed web page offset if needed to prevent the scaled image from extending beyond the boundaries of the background image.

18. The process of claim 17, wherein the text area of the background image, the scaled logo and the cropped and scaled image are component elements of the web page visual summarization, and wherein each component element is allowed to overlap one or both of the other component elements.

19. The process of claim 14, wherein the prescribed size of the background image is 120×90 pixels.

20. A web page visual summarization system, comprising:
a general purpose computing device comprising a display; and
a computer program comprising program modules executable by the computing device, wherein the computing device is directed by the program modules of the computer program to display a visual summarization of a web page on the display comprising,
a background image depicting at least a part of the web page as it would appear scaled to a prescribed smaller size, and
a plurality of sectors overlying the background image which are smaller than the background image and which do not extend past the boundaries of the background image, said sectors comprising,
an image sector depicting an image associated with the web page that is exemplary of the page content,
a text sector displaying text associated with the web page that is exemplary of the page content, and
a logo sector displaying a logo associated with the web page.
